(19) United States
(12) Patent Application Publication
(10) Pub. No.: US 2023/0160762 A1
(43) Pub. Date: May 25, 2023

(54) Pressure Sensing Element with Porous Structure Based Flexible Base

(71) Applicant: National Taiwan University of Science and Technology, Taipei 106 (TW)

(72) Inventors: Ming-Jong Tsai, Taipei (TW); Ming-Hua Ho, Taipei (TW); Chun-Hung Wang, Taipei (TW); Huan-Yuan Huang, Taipei (TW)

(21) Appl. No.: 17/846,218

(22) Filed: Jun. 22, 2022

(30) Foreign Application Priority Data
Nov. 25, 2021 (TW) 110143878

(51) Int. Cl. G01L 1/16

(52) U.S. Cl. CPC G01L 1/16

(57) ABSTRACT

A pressure sensing element has an elastic porous substrate, an electrode, an upper protective layer, and a lower protective layer. The elastic porous substrate is provided with a piezoelectric layer on a surface of the elastic porous substrate. The electrode is formed on at least one of a top and a bottom of the elastic porous substrate. The upper protective layer and a lower protective layer are provided respectively above and below the elastic porous substrate. The elastic porous substrate has multiple holes arranged in regular and repetitive patterns including gyroidal structures, lattice structures or schwarz structures.

### FIELD OF INVENTION

The present invention relates to a pressure sensing element, particularly to a pressure sensing element with a porous structure based flexible base that can be deformed to generate impedance change based on an external force.

### BACKGROUND OF THE INVENTION

A pressure sensor is a device for transferring pressure into electrical signal. When an external force is applied to a pressure sensing element, the pressure will be transferred into an electrical signal and the electrical signal is output. The conventional pressure sensing element includes capacitive type, piezoresistive type, or piezoelectric type. However, the conventional pressure sensing element is not sensitive for pressure detecting, so the conventional pressure sensing element cannot output an effective and sensitive signal.

Some conventional pressure sensing elements comprises a substrate having multiple micro-channels or elastic material, such as sponge to enhance the deformation of the pressure sensing element and to improve the sensitivity of the pressure sensing element. However, the effect of such conventional way is not significant. Another conventional pressure sensing element comprises multiple micro-channels filled with ionic liquid for enhancing the pressure-detecting effect of the pressure sensing element. However, the conventional pressure sensing element cannot maintain high sensitive for a long term in many conditions. The problems of the conventional pressure sensing element have to be solved.

### SUMMARY OF THE INVENTION

The objective of the present invention is to provide a pressure sensing element has an elastic porous substrate, an electrode, an upper protective layer, and a lower protective layer. The elastic porous substrate is provided with a piezoelectric layer on a surface of the elastic porous substrate. The electrode is formed on at least one of a top and a bottom of the elastic porous substrate. The upper protective layer and a lower protective layer are provided respectively above and below the elastic porous substrate. The elastic porous substrate has multiple holes arranged in regular and repetitive patterns including gyroidal structures, lattice structures or schwarz structures.

Wherein, the elastic porous substrate is formed with an additive manufacturing process.

Wherein, the piezoelectric layer is made of zinc oxide (ZnO), barium titanate (BaTiO₃), lead zirconium titanate (PZT), or polyvinylidene difluoride (PVDF).

Wherein, the upper electrode and the lower electrode are made of conductive sliver glue, carbon nanotube, gold electrode, sliver electrode, or copper electrode.

Wherein, the upper protective layer and the lower protective layer are made of polymer material or plastic material.

Wherein, the elastic porous substrate is made of thermoplastic material or thermoplastic polyurethane.

### BRIEF DESCRIPTION OF THE DRAWINGS

FIG. 1 is a perspective view of a first embodiment of a pressure sensing element in accordance with the present invention;

FIG. 2 is a perspective view of a second embodiment of a pressure sensing element in accordance with the present invention;

FIGS. 3A to 3F show multiple embodiments of elastic porous substrates in accordance with the present invention; and

FIGS. 4A and 4B show a diagram for Young's modulus and signal of the pressure sensing element in accordance with the present invention.

### DETAILED DESCRIPTION OF THE PREFERRED EMBODIMENTS

Other objects, advantages and novel features of the invention will become more apparent from the following detailed description when taken in conjunction with the accompanying drawings.

In the specification of the application, the term a, one, one kind or the does not express single but also can express plural. Generally, the term comprise and include indicate to have the components and steps being listed, and the list is not exclusive. The method or device may have another steps or components.

### First Embodiment

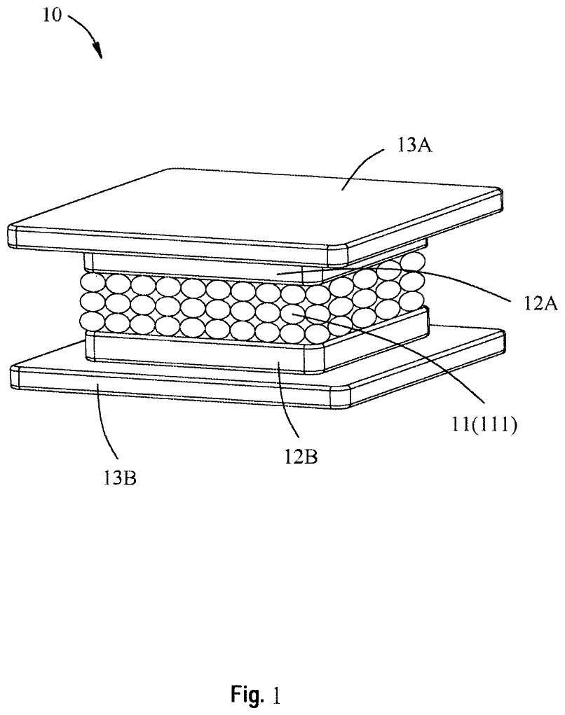

With reference to FIG. 1, a pressure sensing element 10 in accordance with the present invention comprises an elastic porous substrate 11, an upper electrode 12A, a lower electrode 12B, an upper protective layer 13A, and a lower protective layer 13B.

The elastic porous substrate 11 is provided with a piezoelectric layer 111 on a surface of the elastic porous substrate 11. The piezoelectric layer 111 is made of zinc oxide (ZnO), barium titanate (BaTiO₃), lead zirconium titanate (PZT), or polyvinylidene difluoride (PVDF).

The upper electrode 12A and the lower electrode 12B are formed respectively on the top and the bottom of the elastic porous substrate 11. The elastic porous substrate may preferably have a thickness of 1 to 10 millimeter (mm). The upper electrode 12A and the lower electrode 12B may be connected with wires for electrical output.

The upper protective layer 13A is attached to the upper electrode 12A, and the lower protective layer 13B is attached to the lower electrode 12B.

The elastic porous substrate 11 and the piezoelectric layer 111 are made of electrically conductive material. The upper electrode 12A and the lower electrode 12B may be made of a coating material such as, conductive sliver glue or carbon nanotube or a conductive material, such as gold electrode, sliver electrode, or copper electrode. The upper protective layer 13A and the lower protective layer 13B may be made of polymer material or plastic material, such as polyimide (PI).

The elastic porous substrate 11 is made of an flexible material, such that the elastic porous substrate 11 can be fitted with complicated curve surfaces.

### Second Embodiment

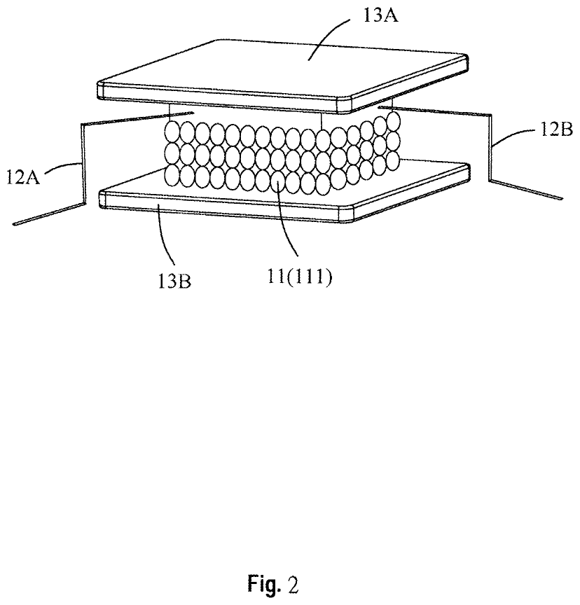

With reference to FIG. 2, the second embodiment of the pressure sensing element 10 in accordance with the present invention is similar to the first embodiment, expect that the upper and lower electrodes 12A, 12B are presented as left and right electrodes12A, 12B. Generally, the electrodes are arranged between the upper protective layer 13A and the piezoelectric layer 111 of the elastic porous substrate 11 and output electrical signal in a left-right form.

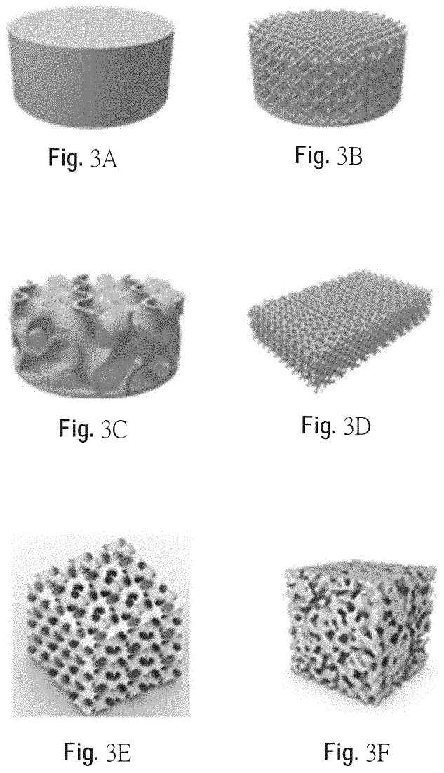

With reference to FIGS. 3A to 3F, embodiments of the elastic porous substrate 11 accordance with the present invention may include Cuboid type without holes in FIG. 3A, WM type in FIG. 3B, Gyroid type in FIG. 3C, Lattice type in FIG. 3D, Schwarz type in FIG. 3E, and porous structure type in FIG. 3F. The elastic porous substrate 11 may have a large deformation while a normal force is applied to the substrate 11.

The WM type shown in FIG. 3B is a cubic grid hole structure. The Gyroid type in FIG. 3C is a porous gyroid structure or a gyroidal structure. The type in FIG. 3D is a lattice structure, and the type in FIG. 3E is a Schwarz structure. The type in FIG. 3F may be a porous structure in any shape.

Method for Forming the Elastic Porous Substrate 11

The elastic porous substrate 11 is formed with an additive manufacturing process (3D printing process). The elastic porous substrate 11 is made of thermoplastic material or thermoplastic polyurethane. A thermoplastic elastomer or a thermoplastic polyurethane elastomer may be added into the material for the elastic porous substrate 11 to adjust the concentration of the material to allow the forming accuracy and the mechanical properties to be fit with demands. The additive manufacturing process may be a photo-Polymerization additive process, such as digital light processing (DLP) or Stereolithography (SLA), a material-extrusion additive process, such as FDM, or a powder bed fusion additive process, such as SLS or SLM. The method for forming the elastic porous substrate 11 is not limited in the present invention.

With the porous structure of the elastic porous substrate 11, the elastic porous substrate 11 provided with the piezoelectric layer 111 and the electrodes 12A, 12B has a large deformation while an external force is applied to the substrate 11.

Testing Result

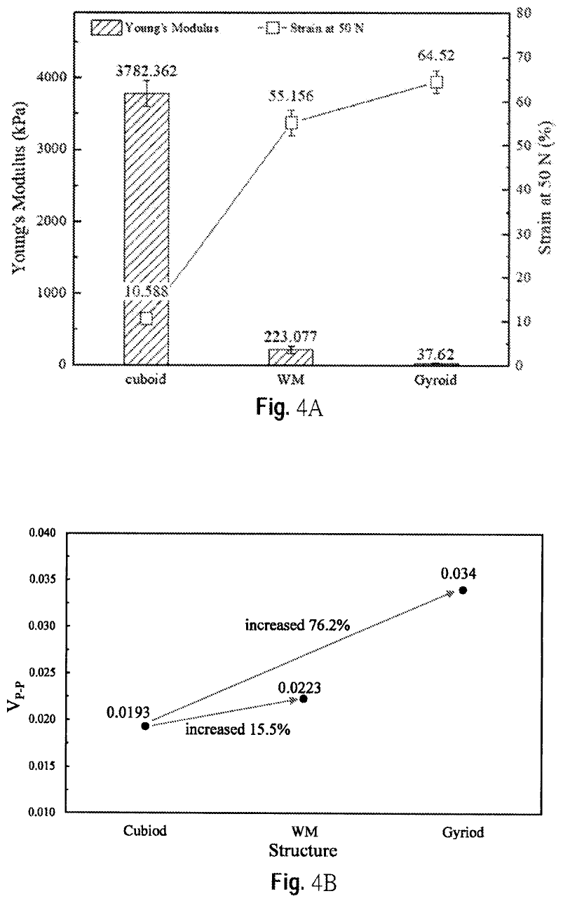

With reference to FIGS. 4A and 4B, a substrate 11 in a WM type shown in FIG. 3B with a thickness of 5.35 mm and a porosity of 76.9% and a substrate 11 in a Gyroid type in FIG. 3C with a thickness 5.35 mm and a porosity of 73.5 are tested and are compared to a cuboid type without holes. The Young's modulus of the elastic porous substrate 11 decreases 94.1% and 99%, and the deformation thereof are increased to 5.2 to 6.1 times while is applied with a force of 50N. Thus, the deformation of the porous structure can be effectively increased.

The Young's modulus of the substrate 11 in W in WM type and Gyroid as shown in FIGS. 4A and 4B decreases above 90%, the Young's modulus can be adjusted based on different demands. When the Young's modulus is decreased 94.1% and 99.0% as shown in FIGS. 4A and 4B, the signal strength of the substrate 11 can be increased 15.5% and 76.2%.

The term of “about” or “substantially” provided with numbers shown in the present invention may allow a change of ±20%. In addition, the numbers used in the embodiments of the present invention are approximation.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A pressure sensing element comprising:
an elastic porous substrate provided with a piezoelectric layer on a surface of the elastic porous substrate;
an electrode formed on at least one of a top and a bottom of the elastic porous substrate; and
an upper protective layer and a lower protective layer provided respectively above and below the elastic porous substrate, wherein
the elastic porous substrate has multiple holes arranged in regular and repetitive patterns including gyroidal structures, lattice structures or schwarz structures.

2. The pressure sensing element as claimed in claim 1, wherein the electrode includes an upper electrode and a lower electrode formed respectively on the top and the bottom of the elastic porous substrate.

3. The pressure sensing element as claimed in claim 2, wherein the elastic porous substrate is formed with an additive manufacturing process.

4. The pressure sensing element as claimed in claim 2, wherein the piezoelectric layer is made of zinc oxide (ZnO), barium titanate (BaTiO₃), lead zirconium titanate (PZT), or polyvinylidene difluoride (PVDF).

5. The pressure sensing element as claimed in claim 2, wherein the upper electrode and the lower electrode are made of conductive sliver glue, carbon nanotube, gold electrode, sliver electrode, or copper electrode.

6. The pressure sensing element as claimed in claim 2, wherein the upper protective layer and the lower protective layer are made of polymer material or plastic material.

7. The pressure sensing element as claimed in claim 2, wherein the elastic porous substrate is made of thermoplastic material or thermoplastic polyurethane.

8. The pressure sensing element as claimed in claim 7, wherein the elastic porous substrate further comprises a thermoplastic elastomer or thermoplastic polyurethane elastomer.

9. The pressure sensing element as claimed in claim 1, wherein the elastic porous substrate is made of thermoplastic material or thermoplastic polyurethane.

10. The pressure sensing element as claimed in claim 9, wherein the elastic porous substrate further comprises a thermoplastic elastomer or thermoplastic polyurethane elastomer.

11. The pressure sensing element as claimed in claim 1, wherein the elastic porous substrate is formed with an additive manufacturing process.

12. The pressure sensing element as claimed in claim 1, wherein the piezoelectric layer is made of zinc oxide (ZnO), barium titanate (BaTiO₃), lead zirconium titanate (PZT), or polyvinylidene difluoride (PVDF).

13. The pressure sensing element as claimed in claim 1, wherein the electrode is made of conductive sliver glue, carbon nanotube, gold electrode, sliver electrode, or copper electrode.

14. The pressure sensing element as claimed in claim 1, Wherein the upper protective layer and the lower protective layer are made of polymer material or plastic material.

15. The pressure sensing element as claimed in claim 14, wherein the elastic porous substrate further comprises a thermoplastic elastomer or thermoplastic polyurethane elastomer.
